(19) United States
(12) Patent Application Publication
(10) Pub. No.: US 2005/0150495 A1
(43) Pub. Date: Jul. 14, 2005

(54) Passenger oxygen mask

(76) Inventors: Wolfgang Rittner, Siblin (DE); Herbert Meier, Lubeck (DE); Rudiger Meckes, Berkenthin (DE); Hasso Weinmann, Lubeck (DE); Christopher L. Lanza, Cheektowaga, NY (US); Wolfgang Marquardt, Snohomisch, WA (US)

Correspondence Address: McGLEW AND TUTTLE, P.C.;Counselors at Law, SCARBOROUGH STATION, SCARBOROUGH, NY, 10510-0827, US

(21) Appl. No.: 11/031,788

(22) Filed: Jan. 7, 2005

(30) Foreign Application Priority Data
Jan. 10, 2004 (DE) 10 2004 001 534.1

(51) Int. Cl. A62B 1/00; A62B 18/02

(52) U.S. Cl. 128/205.13; 128/206.21

(57) ABSTRACT

The passenger oxygen mask is provided for emergency situations on board an aircraft. The mask body is designed collapsible at least in sections. An axial overall height of the mask body is reduced by way of the one or more mask sections. This simplifies the accommodation of the oxygen mask or even permits a smaller constructional size of the preparation device.

### CROSS REFERENCE TO RELATED APPLICATIONS

This application claims the benefit of priority under 35 U.S.C. § 119 of German Patent Application DE10 2004 001 534.1 filed Jan. 10, 2004, the entire contents of which are incorporated herein by reference.

### FIELD OF THE INVENTION

The invention relates to a passenger oxygen mask such as oxygen masks used in aircraft.

### BACKGROUND OF THE INVENTION

In the aircraft of almost all airlines an oxygen mask is provided for each air passenger seat in the case of an emergency situation of a sudden drop in pressure occurring during flight at high altitude. The passenger oxygen masks are located in service units which for each seating group are usually located below the baggage compartments located in the upper cabin region. On reaching a certain pressure level, the oxygen masks hanging on belts fall automatically out of the service units. The belts are connected to a mechanism which activates the oxygen supply on pulling down the masks.

Apart from the oxygen masks, the oxygen generators or connection fittings of an external oxygen source, as well as comfort elements such as e.g. reading lights, steward call buttons, ventilation nozzles, optical displays and supply leads of these elements are installed in the service units. Accordingly, the space available for these safety and comfort elements is quite small.

### SUMMARY OF THE INVENTION

Proceeding from this, it is the object of the invention to provide a passenger oxygen mask which is optimally adapted to the low spatial conditions in the service unit, but at the same time fulfils those ergonomic requirements for the breathing situation.

According to the invention a passenger oxygen mask is provided with at least parts of the mask body of a passenger oxygen mask formed or provided in a collapsible manner, by way of folds. This permits the reduction of axial overall height of the mask body, i.e. the distance between the sealing frame of the mask body which connects to the face and the proximal end of the mask body which is distant to this and to which a collection or retention flexible bag with a flexible tubing for the oxygen supply is connected. At the same time the number of folds in principle is infinite. In this manner the volume which is required in the service unit for accommodating the oxygen mask may be considerably reduced. The folding is effected by way of a mechanical force action, for example in the installation position of the service unit.

Advantageously the collapsible section of the mask body is arranged on that side of the sealing frame of the mask body connecting to the face, which is distant to the face. Thus the mask body which essentially has the form of a shell and consists of semi-elastic or elastic material may be compressed whilst the sealing frame whose contour is adapted to the shape of the face in the mask region is intrinsically stiff and may not be manipulated.

Usefully, the mask body in the region of the collapsible section is designed to unfold in an automatic manner. By way of this it is ensured that the passenger oxygen masks which are put away in the folded condition in the service units during normal flight operation and which fall from these given a pressure loss, unfold automatically and are thus available ready for use by the passengers.

Preferably the collapsible section of the mask body is designed in the manner of a bellows, i.e., the outer wall of the mask body in this section is folded in a manner such that peaks and troughs alternate in a regular manner. The bellows-like design of a section of the mask body permits the reduction of the overall height of the mask body since these may be compressed so much until the limbs of a fold which limit a peak or trough lie almost on one another.

Advantageously the collapsible section of the mask body is formed by crease folds. With this folding, the limbs of the peaks and troughs form corners. These corners form predefined crease locations for the compression of the mask body.

In place of crease folds, the collapsible section of the mask body may also have a wave-like folding. A uniform course of stress in the wall of the folded region results on account of this and thus a different loading of the material, which may be advantageous depending on the material applied.

Preferably the mask body comprises shape-stable support rings which are connected by elastic sleeves which are arranged therebetween. The support rings whose shape stability is increased by an enlarged wall thickness, shaping and/or the use of distortion-resistant materials, are arranged on the periphery of the mask body and give it the required stability in the radial direction. The elastic sleeves provided between the support rings permit the compression of the mask body in the direction of its overall height.

The collapsible section of the mask body advantageously comprises a spring helix. The spring helix circles around the elastic mask body or at least a part of this in a spiral-like manner. On compression, the mask body with the spring helix is pressed together against the effect of the spring force of the spring helix. When the compression force is relieved the spring helix is relaxed so that the mask body assumes its shape which is ready for application.

It is useful to incorporate a separate spring helix in the mask body. Thus during the manufacture of the mask body this spring helix may be cast into this without the structure of the spring helix affecting the surfaces of the mask body.

Advantageously the spring helix may also be designed as an integral spiral-shaped material thickening of the mask body. In this manner one requires no separate spring helix which needs to be fastened or cast on the mask body.

Preferably the spring helix is arranged on a wall of the mask body. With this the spring helix is preferably fastened on the inner side of the mask body.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

The invention is hereinafter explained by way of embodiment examples shown in the drawings. There are shown in:

FIG. 1 is a schematic front view of a mask body with a collapsible section with crease folds;

FIG. 2 is a schematic front view of a mask body with shape-stable support rings and elastic sleeves arranged therebetween;

FIG. 3 is a schematic front view of a mask body which comprises a spring helix; and

FIG. 4 is a schematic front view of a mask body with an inwardly directed folding, in a sectioned view.

### DESCRIPTION OF THE INVENTION

Referring to the drawings in particular, FIG. 1 shows a principle sketch of a mask body 2 with a collapsible section 4 which is formed by crease folds 10. The mask body 2 has the shape of a hollow truncated cone, wherein the base surface of the truncated cone is adapted to the shape of the face and is bordered around by a correspondingly shaped sealing frame 6 which in the case of application is applied onto the face. The elements of the oxygen supply and discharge (not shown in detail here) are arranged in the manner known per se at the connection 8 which is distant to the base surface and which is integrated into the mask body 2 or is formed as a separate part. The collapsible section 4 is located close to the connection 8, between the sealing frame 6 and the connection 8. This has the shape of a bellows and in FIG. 1 consists of two crease folds 10 which are represented in the unfolded condition. The crease folds 10 lie on the outside with respect to the mask body 2, but as represented in FIG. 4 may also be arranged lying on the inside. The crease folds 10 form peripheral peaks 12 and troughs 14 and are formed by the fold limbs 15. Folded together, the annular fold limbs 15 in each case of one peak 12 and trough 14 respectively lie almost on one another.

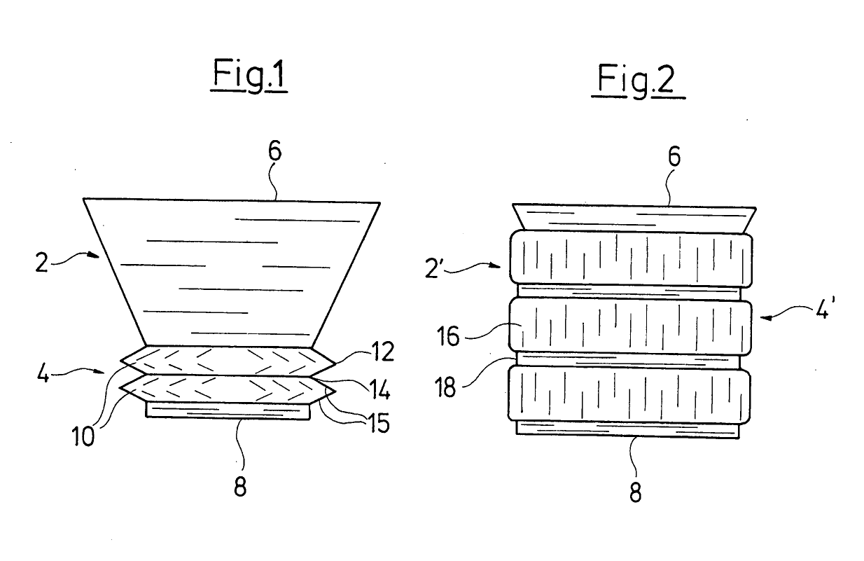

One embodiment variant of a mask body 2′ is shown in FIG. 2, which comprises a collapsible section 4′ which is formed of shape-stable support rings 16 and elastic sleeves 18 arranged therebetween. The collapsible section 4′ in FIG. 2 consists of three support rings 16 and two sleeves 18. The bead-like support rings 16 are annular and form the support body of the mask body 2. The elastic sleeves 18 are arranged set back between these and are folded on axial compression and when released automatically extend into the extended position shown in FIG. 2.

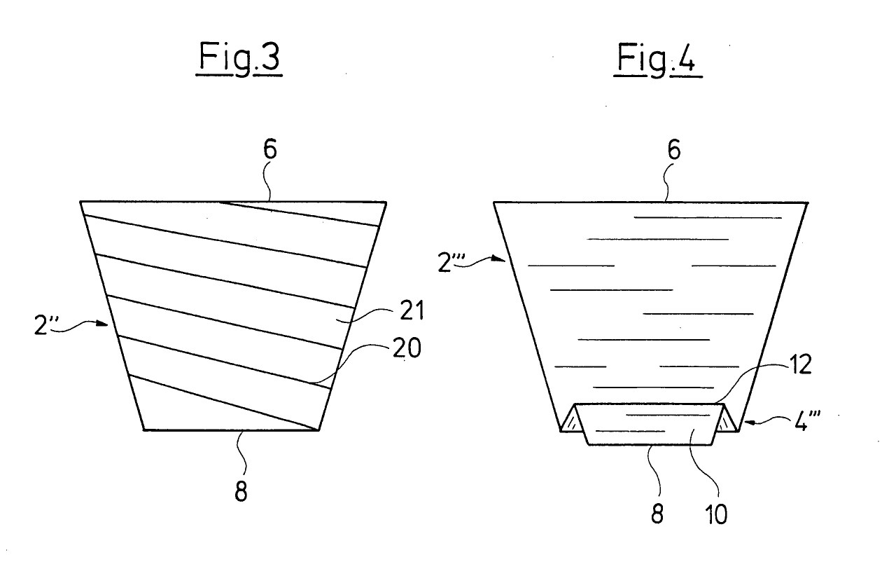

FIG. 3 shows one embodiment of a mask body 2″ which comprises a spring helix 20. The spring helix 20 extends over the whole peripheral surface of the mask body 2″ between the sealing frame 6 and the connection 8 and according to the shape of the mask body 2″ has the shape of a conically widening spiral. The spring helix 20 here forms the actual support body of the mask body 2″ and ensures that this after release automatically unfolds into the position shown in FIG. 3. The spring helix 20 lies on the inner side of an elastic skin 21 or is incorporated into such as skin. The skin 21 is soft elastic and is not intrinsically stable so that it collapses given a force effort on the spring in the axial direction. This embodiment may be collapsed in a particularly space saving manner since almost the complete mask body 2″ may be collapsed, and only and essentially intrinsically stable sealing frame 6 as well as the connection 8 are designed in a reinforced manner. The spring helix 20 may also be formed by a separate spring or by and integral spiral-shaped material thickening of the material of the mask body 2″.

One side view of a mask body 2″ with an inwardly directed folding in a section 4′″ is represented in FIG. 4. The folding here is likewise in the manner of a bellows as with the embodiment variant represented by way of FIG. 1, but it lies within the essentially truncated-cone-shaped outer contour which is formed by the actual mask body 2″. The folding here consists of a crease fold 11 which connects directly to the connection 8.

While specific embodiments of the invention have been shown and described in detail to illustrate the application of the principles of the invention, it will be understood that the invention may be embodied otherwise without departing from such principles.

1. A passenger oxygen mask, comprising a mask body collapsible at least in sections for reducing an overall axial height.

2. A passenger oxygen mask according to claim 1, wherein said mask body has a sealing frame side that is to be distant to the face of the user with a collapsible section.

3. A passenger oxygen mask according to claim 1, wherein the mask body has a collapsible section for unfolding in an automatic manner.

4. A passenger oxygen mask according to claim 1, wherein the mask body has a collapsible section in the form of a bellows.

5. A passenger oxygen mask according to claim 1, wherein the mask body has a collapsible section in the form of crease folds.

6. A passenger oxygen mask according to claim 1, wherein the mask body has a collapsible section having wavelike folded portions.

7. A passenger oxygen mask according to claim 1, wherein the mask body has a collapsible section comprising shape-stable support rings connected by elastic sleeves which are arranged therebetween.

8. A passenger oxygen mask according to claim 1, wherein the mask body has a collapsible section comprising a spring helix.

9. A passenger oxygen mask according to claim 8, wherein a separate spring helix is incorporated into the mask body.

10. A passenger oxygen mask according to claim 8, wherein the spring helix is designed as an integral, spiral-shaped material thickening of the mask body.

11. A passenger oxygen mask according to claim 8, wherein the spring helix is arranged on a wall of the mask body.

12. An airline passenger oxygen mask, comprising:
a mask body having a user interface sealing end which connects to the face and an opposite oxygen supply connection end to which a collection or retention flexible bag with a flexible tubing for the oxygen supply is connected, said mask body having a collapsible section between said user interface sealing end and said oxygen supply connection end, said collapsible section reducing an overall axial extent of the mask body between said user interface sealing end and said oxygen supply connection end.

13. A passenger oxygen mask according to claim 12, wherein said collapsible section includes means for automatically extending from a collapsed state to an axially extended state.

14. A passenger oxygen mask according to claim 12, wherein said collapsible section includes a bellows.

15. A passenger oxygen mask according to claim 12, wherein said collapsible section includes crease folds.

16. A passenger oxygen mask according to claim 12, wherein said collapsible section includes wavelike folded portions.

17. A passenger oxygen mask according to claim 12, wherein said collapsible section includes shape-stable support rings with connected and interposed elastic sleeves.

18. A passenger oxygen mask according to claim 12, wherein said collapsible section includes a spring helix.

19. A passenger oxygen mask according to claim 18, wherein said spring helix comprises an spiral-shaped material thickening formed integral with a portion of material defining said mask body.
